(19) United States
(12) Patent Application Publication
(10) Pub. No.: US 2016/0026567 A1
(43) Pub. Date: Jan. 28, 2016

(54) DIRECT MEMORY ACCESS METHOD, SYSTEM AND HOST MODULE FOR VIRTUAL MACHINE

(71) Applicant: NATIONAL TSING HUA UNIVERSITY, Hsinchu City (TW)

(72) Inventors: MING-TING WEI, HSINCHU CITY (TW); CHE-RUNG LEE, HSINCHU CITY (TW)

(21) Appl. No.: 14/504,085

(22) Filed: Oct. 1, 2014

(30) Foreign Application Priority Data
Jul. 22, 2014 (TW) 103125121

(51) Int. Cl. G06F 12/08

(52) U.S. Cl. CPC G06F 12/0802; G06F 2212/65; G06F 2212/2542

(57) ABSTRACT

The present disclosure provides a direct memory access method, system and host module for a virtual machine. The direct memory access method comprises the following steps. Firstly, a host virtual memory address is acquired according to a guest physical memory address. Next, a shared-memory is configured to access data corresponding to the host virtual memory address. Then, the shared-memory is mapped to a continuous memory having a plurality of continuous memory addresses. Finally, the continuous memory is utilized to provide an apparatus driver to access the data corresponding to the host virtual memory address.

### BACKGROUND

1. Technical Field

The present disclosure relates to a direct memory access method and system, in particular, to a direct memory access method, system and host module for a virtual machine.

2. Description of Related Art

Virtualization is a common way to allocate computing resources. The operation cost of the virtual machine is cheaper since virtualization is supported by various kinds of hardware. The execution speed of the virtual machine can equal the real apparatus, and can work in high performance computing (HPC). The input/output (I/O) is an important factor for evaluating HPC. Although virtualization can bring extra cost, current virtualization technology such as single root I/O virtualization (SR-IOV) or Paravirtualzation can in fact reduce the extra cost.

Currently HPC utilizes the high speed communication interface card or the hardware acceleration card. For reducing the consumption of the computing resource, the hardware mostly performs direct memory access (DMA) to the large-scale memory. Thus, the memory allocating is an important issue for supporting the hardware to be operated in the virtual machine. Conventionally, the operating system (OS) allocates the memory for each program in the paging mechanism so that memory is divided in fixed paging and utilizes the memory management to perform mapping. Therefore, each program includes a virtual memory addressing space. However, a physical memory addressing space mapping to the virtual memory addressing space can be continuous or non-continuous.

Please refer to FIG. 1. FIG. 1 shows a diagram of direct memory access between a host memory addressing space and a guest addressing space for virtual machine in the conventional art. A guest virtual memory addressing space 101, a guest physical memory addressing space 102 and a host virtual memory addressing space 103 are shown in FIG. 1. The guest virtual memory addressing space 101, the guest physical memory addressing space 102 and the host virtual memory addressing space 103 respectively include guest virtual memory addresses 101a-101d, guest physical memory addresses 102a-102d and host virtual memory addresses 103a-103d.

In the virtual machine, the guest physical memory addresses 101a-101d in the guest virtual memory addressing space 101 are continuous, but that does not guarantee the guest physical memory addresses 102a-102d in the guest physical memory addressing space 102 and the host virtual memory addresses 103a-103d the host virtual memory addressing space 103 are continuous. However, the apparatus which can perform DMA to large-scale memory has to copy the transmission data by using the continuous space of the virtual memory addressing space in execution. Thus, the conventional transmission method cannot raise the efficiency by copying to the continuous space.

### SUMMARY

An exemplary embodiment of the present disclosure provides a direct memory access method for a virtual machine The method comprises the following steps. Firstly, a host virtual memory address is acquired according to a guest physical memory address. Next, a shared-memory is configured to access data corresponding to the host virtual memory address. Then, the shared-memory maps to a continuous memory having a plurality of continuous memory addresses. Finally, the continuous memory is utilized to provide an apparatus driver to access the data corresponding to the host virtual memory address.

An exemplary embodiment of the present disclosure provides a direct memory access system for a virtual machine The system comprises at least one guest module and a host module. The host module comprises a memory, an apparatus driver and a virtual input/output processor. The apparatus driver couples to the memory. The virtual input/output processor couples to the memory and the apparatus driver. The at least one guest module generates a guest physical memory address. The virtual input/output processor acquires a host virtual memory address according to the guest physical memory address, configures a shared-memory to access data corresponding to the host virtual memory address, and maps the shared-memory to a continuous memory having a plurality of continuous memory addresses, wherein the apparatus driver utilizes the continuous memory to access the data corresponding to the host virtual memory address.

An exemplary embodiment of the present disclosure provides a host module adapted to access data for a virtual machine The host module couples to at least a guest module. The at least guest module provides a guest virtual memory address to acquire a guest physical memory address. The host module comprises a memory, an apparatus driver and a virtual input/output processor. The apparatus driver couples to the memory. The virtual input/output processor couples to the memory and the apparatus driver. The virtual input/output processor acquires a host virtual memory address according to the guest physical memory address, configures a shared-memory to access data corresponding to the host virtual memory address, and maps the shared-memory to a continuous memory having a plurality of continuous memory addresses, wherein the apparatus driver utilizes the continuous memory to access the data corresponding to the host virtual memory address.

To sum up, the direct memory access method, the system and the host module for a virtual machine can map the non-continuous memory in the host virtual memory addressing space to the continuous memory addresses. Therefore, the apparatus can directly access the assigned memory paging of the guest module (no matter whether continuous memory paging or non-continuous memory paging), and the data does not need to be copied to another continuous memory space, to raise the efficiency of the accessing speed.

In order to further understand the techniques, means and effects of the present disclosure, the following detailed descriptions and appended drawings are hereby referred to, such that, and through which, the purposes, features and aspects of the present disclosure can be thoroughly and concretely appreciated, however, the appended drawings are merely provided for reference and illustration, without any intention that they be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows a diagram that direct memory access between a host memory addressing space and a guest addressing space for virtual machine in the conventional art;

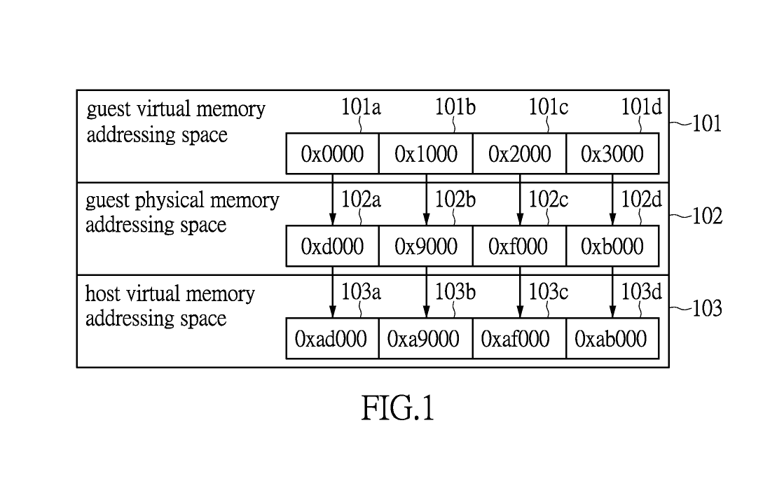

FIG. 2 shows a diagram of a direct memory access system for a virtual machine in an embodiment according to the present disclosure;

FIG. 3 shows a diagram of direct memory access between a host memory addressing space and a guest addressing space for a virtual machine in an embodiment according to the present disclosure;

FIG. 4 shows a diagram of direct memory access between a host memory addressing space and a guest addressing space for a virtual machine in another embodiment according to the present disclosure;

FIG. 5 shows a flowchart of a direct memory access method for a virtual machine in an embodiment according to the present disclosure.

### DESCRIPTION OF THE EXEMPLARY EMBODIMENTS

Reference will now be made in detail to the exemplary embodiments of the present disclosure, examples of which are illustrated in the accompanying drawings.

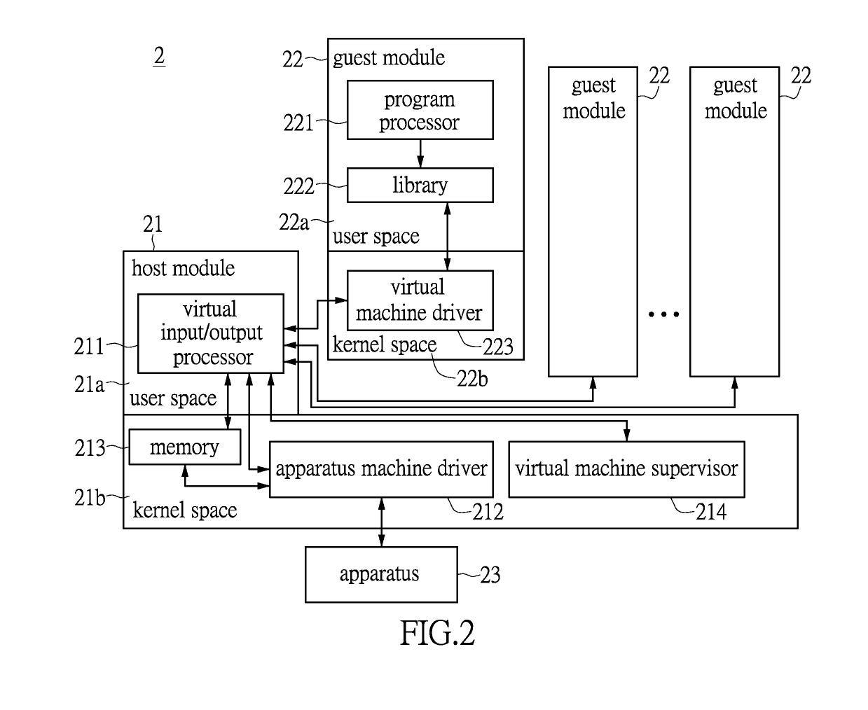

FIG. 2 shows a diagram of a direct memory access system for a virtual machine in an embodiment according to the present disclosure. The direct memory access system 2 includes a host module 21, a guest module 22 and an apparatus 23. The host module 21 includes user space 21a and kernel space 21b. The guest module 22 includes user space 22a and kernel space 22b. The user space 21a of the host module 21 further includes a virtual input/output processor 211, and the kernel space 21b of the host module 21 further includes an apparatus machine driver 212, a memory 213 and a virtual machine supervisor 214. The user space 22a of the guest module 22 further includes a program processor 221 and a library 222, and the kernel space 22b of the guest module 22 further includes a virtual machine driver 223. The apparatus machine driver 212, the memory 213 and the virtual machine supervisor 214 couple to the virtual input/output processor 211, and the memory 213 couples to the apparatus machine driver 212. The program processor 221 couples to the library 222, and the library 222 couples to the virtual machine driver 223. The virtual machine driver 223 of the guest module 22 couples to the virtual input/output processor 211 of the host module 21. The apparatus 23 couples to the apparatus machine driver 212.

In an embodiment of the present disclosure, the host module 21 is the main operation system, and the guest module 22 is the simulation operation system. Users can perform any operation system by a virtual machine as is known by the person skilled in the art. For example, the multiplex operation systems can be simulated on the personal computer. However, the embodiment of the present disclosure takes Type 2 hypervisor to illustrate as follows. More specifically, in the Type 2 of virtual machine manager (VMM), the virtual machine supervisor 214 generates four memory addressing spaces, such as host physical memory addressing space, host virtual memory addressing space, guest physical memory addressing space and guest virtual memory addressing space. Actually, these can be implemented by QEMU, KVM or etc., and the present disclosure is not limited thereto.

The host physical memory addressing space, the host virtual memory addressing space, the guest physical memory addressing space and the guest virtual memory addressing space generated by the virtual machine supervisor 214 correspond to the kernel space 21b, the user space 21a, the kernel space 22b and the user space 22a. The user spaces 21a and 22a are configured to provide for the user operating. In other words, the user operates the host module 21 to execute by the user space 21a. The kernel spaces 21b and 22b are looked at as operating core for the hardware of the apparatus and the hardware of the simulated virtual machine respectively.

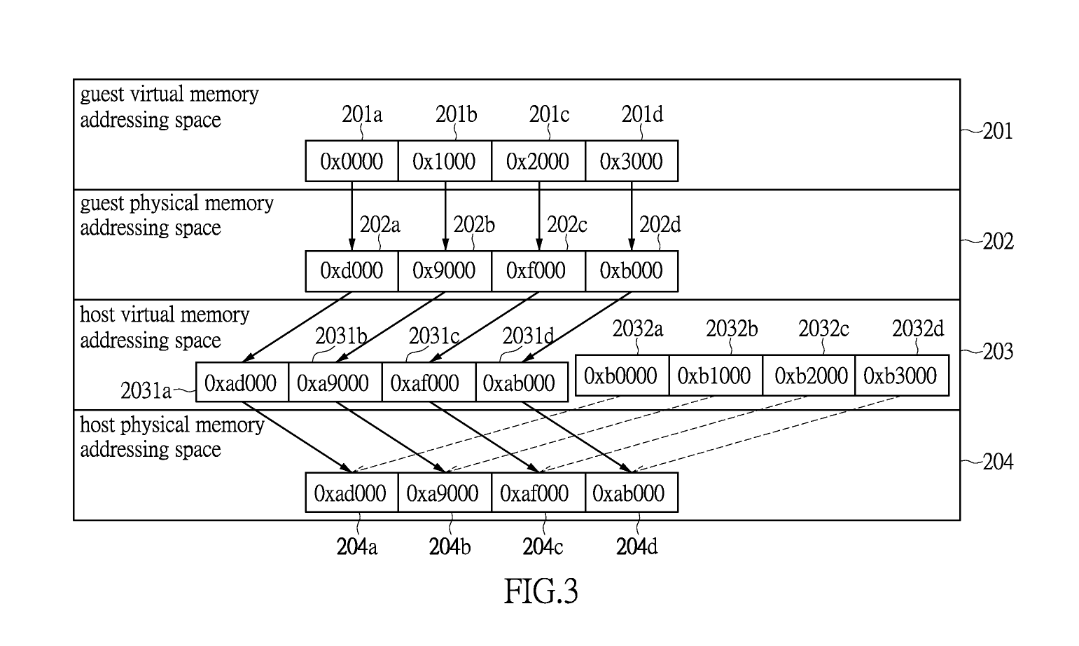

Please refer to FIG. 3 in conjunction with FIG. 2. FIG. 3 shows a diagram of direct memory access between a host memory addressing space and a guest addressing space for a virtual machine in an embodiment according to the present disclosure. A guest virtual memory addressing space 201, a guest physical memory addressing space 202, a host virtual memory addressing space 203 and a host physical memory addressing space 204 are shown in FIG. 3, which correspond to the kernel space 22b, the user space 22a, the user space 21a and the kernel space 21b in a broad sense. Shown as FIG. 3, the guest virtual memory addressing space 201 includes guest virtual memory addresses 201a-201d, guest physical memory addressing space 202 includes guest physical memory addresses 202a-202d, the host virtual memory addressing space 203 includes host virtual memory addresses 2031a-2031d, 2032a-2032d and the host physical memory addressing space 204 includes host physical memory addresses 204a-204d. Furthermore, the guest virtual memory addresses 201a-201d are continuous memory paging addresses (such as FIG. 3, the guest physical memory addresses 202a-202d are to be 0x0000, 0x1000, 0x2000 and 0x3000), the guest physical memory addresses 202a-202d are non-continuous memory paging addresses (such as FIG. 3, guest physical memory addresses 202a-202d are to be 0xd000, 0x9000, 0xf000 and 0xb000), and the host virtual memory addresses 2031a-2031d are non-continuous memory paging addresses (such as FIG. 3, host virtual memory addresses 2031a-2031d are to be 0xad000, 0xa9000, 0xaf000 and 0xab000). It is worth to note, the host virtual memory addresses 2031a-2031d are the fixed shift for the guest physical memory addresses 202a-202d.

In the guest module 22, the program processor 221 comprises suitable circuitry, logic and/or codes. In the embodiment of the present disclosure, the program processor 221 is configured to provide for the user to perform the program. For instance, the user can perform the corresponding program using the program processor 221, and further execute the followed operation by the library 222.

The library 222 comprises suitable circuitry, logic and/or codes. In the embodiment of the present disclosure, the library 222 is configured to provide the guest virtual memory address 201a-201d when the user requires a memory space by the program processor 221. Then, the library 222 further transmits the guest virtual memory address 201a-201d to the virtual machine driver 223.

The virtual machine driver 223 comprises suitable circuitry, logic and/or codes. In the embodiment of the present disclosure, the virtual machine driver 223 pins memory for the guest virtual memory addresses 201a-201d to acquire a guest physical memory address. More specifically, pinning memory by virtual machine driver 223 avoids the memory space being swapped. The guest physical memory addresses 202a-202d of the guest physical memory addressing space 202 are acquired by the guest virtual memory address 201a-201d (including the location and the size).

In the host module 21, the virtual input/output processor 211 comprises suitable circuitry, logic and/or codes. In an embodiment of the present disclosure, the virtual input/output processor 211 is configured to acquire the host virtual memory addresses 202a-202d according to the host virtual memory addresses 2031a-2031d of the host physical memory addressing space 203. Additionally, the virtual input/output processor 211 is further configured to provide the host virtual memory addresses 2032a-2032d (such as a plurality of continuous memory). Similarly, the host physical memory addressing space 203 includes the host virtual memory addresses 2032a-2032d. It is worth to note, the order of the continuous memory paging addresses of the guest virtual memory addresses 201a-201d is equal to the order of the host virtual memory addresses 2032a-2032d (that is, the continuous memory).

The memory 213 comprises suitable circuitry, logic and/or codes. In the embodiment of the present disclosure, the memory 213 is configured to provide a shared-memory to the host physical memory addresses 2031a-2031d corresponding to the accessing host physical memory addresses 204a-204d. It is worth to note, the order of the guest virtual memory address 201a-201d is equal to the order of the host virtual memory addresses 2032a-2032d.

The apparatus machine driver 212 comprises suitable circuitry, logic and/or codes. In the embodiment of the present disclosure, the apparatus machine driver 212 provides the interface for connecting the apparatus 23. More specifically, the apparatus machine driver 212 provides the guest module 22 and the host module 23 using the apparatus 23 by accessing the memory 23.

In an embodiment of the present disclosure, the apparatus 23 is the high speed communication interface card (i.e., InfiniBand, Fiber channel, PCIe switch) or the hardware acceleration card (i.e., GPU, FPGA), and the present disclosure is not limited thereto.

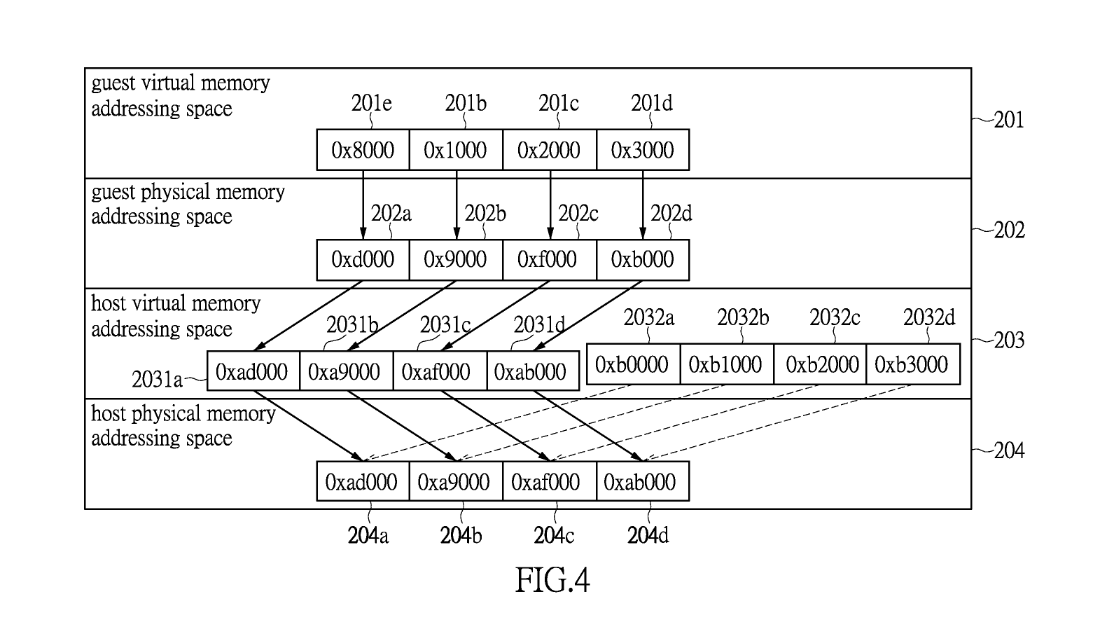

Please refer to FIG. 4. FIG. 4 shows a diagram of direct memory access between a host memory addressing space and a guest addressing space for a virtual machine in another embodiment according to the present disclosure. The difference between FIG. 3 and FIG. 4 is the guest virtual memory addresses 201e, 201b-201d of the guest virtual memory addresses is non-continuous (such as FIG. 4, the guest virtual memory addresses 201e is 0x8000). In this embodiment, the guest physical memory addresses 202a-202d are still non-continuous memory paging address, and the host virtual memory addresses 2031a-2031d are still non-continuous memory paging addresses. Similarly, the order of the continuous memory paging address of the guest virtual memory address 201e, 201b-201d is equal to the order of the host virtual memory addresses 2032a-2032d.

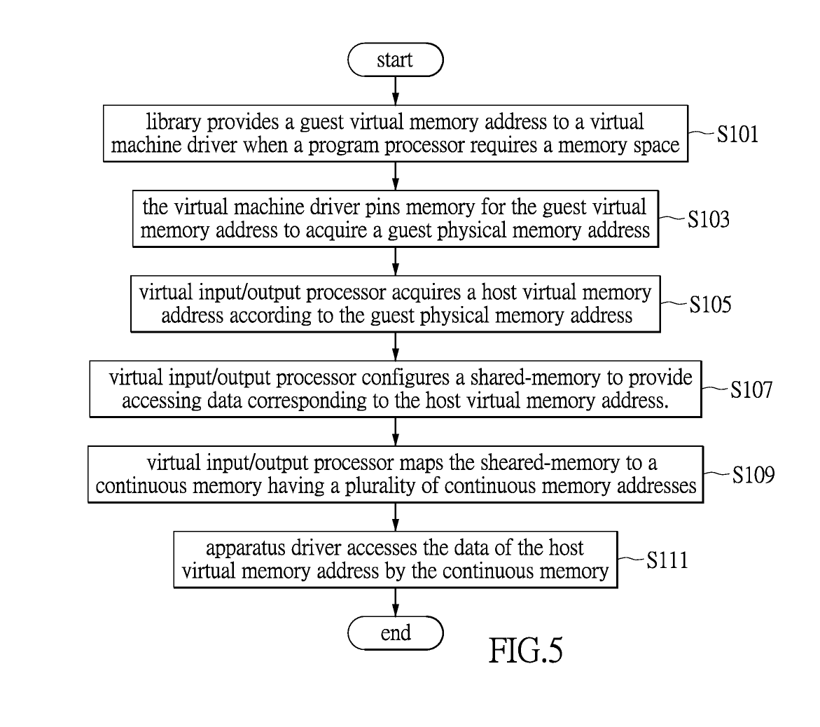

Please refer to FIG. 5. FIG. 5 shows a flowchart of a direct memory access method for a virtual machine in an embodiment according to the present disclosure. The direct memory access method comprises the following steps: STEP 101, library provides a guest virtual memory address to a virtual machine driver when a program processor requires a memory space; STEP 103, the virtual machine driver pins memory for the guest virtual memory address to acquire a guest physical memory address; STEP 105, virtual input/output processor acquires a host virtual memory address according to the guest physical memory address; STEP 107, virtual input/output processor configures a shared-memory to provide accessing data corresponding to the host virtual memory address; STEP 109, virtual input/output processor maps the shared-memory to a continuous memory having a plurality of continuous memory addresses; STEP 111, apparatus driver accesses the data of the host virtual memory address by the continuous memory.

Please refer to FIG. 5 in conjunction with FIG. 3. In the embodiment of the present disclosure, the guest virtual memory addresses 201a-201d are continuous memory paging addresses (such as FIG. 3, the guest physical memory addresses 202a-202d are 0x0000, 0x1000, 0x2000 and 0x3000), the guest physical memory addresses 202a-202d are non-continuous memory paging addresses (such as FIG. 3, guest physical memory addresses 202a-202d are 0xd000, 0x9000, 0xf000 and 0xb000), and the host virtual memory addresses 2031a-2031d are non-continuous memory paging addresses (such as FIG. 3, host virtual memory addresses 2031a-2031d are 0xad000, 0xa9000, 0xaf000 and 0xab000), wherein the order of the continuous memory paging address of the guest virtual memory address 201a-201d is equal to the order of the host virtual memory addresses 2032a-2032d.

Please refer to FIG. 5 in conjunction with FIG. 4. The guest virtual memory addresses 201e, 201b-201d are non-continuous (such as FIG. 4, the guest virtual memory addresses 201e is to be 0x8000), the guest physical memory addresses 202a-202d are non-continuous memory paging address, and the host virtual memory addresses 2031a-2031d are still non-continuous memory paging addresses, wherein the order of the continuous memory paging address of the guest virtual memory address 201e, 201b-201d is equal to the order of the host virtual memory addresses 2032a-2032d.

To sum up, the direct memory access method, the system and the host module for virtual machine can map the non-continuous memory in the host virtual memory addressing space to the continuous memory addresses. Therefore, the apparatus can directly access the assigned memory paging of the guest module (no matter whether continuous memory paging or non-continuous memory paging), and the data does not need to be copied to another continuous memory space, to raise the efficiency of the accessing speed. Thus, the embodiment of the present disclosure can directly access the memory of the hardware acceleration card or the high speed communication interface card for high performance computing of the computer in virtualization.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A direct memory access method for a virtual machine, comprising:
acquiring a host virtual memory address according to a guest physical memory address;
configuring a shared-memory to access data corresponding to the host virtual memory address;
mapping the shared-memory to a continuous memory having a plurality of continuous memory addresses; and
utilizing the continuous memory to provide an apparatus driver to access the data corresponding to the host virtual memory address.

2. The direct memory access method for a virtual machine according to claim 1, before acquiring the host virtual memory address according to the guest physical memory address, a library providing a guest virtual memory address to acquire the guest physical memory address.

3. The direct memory access method for virtual machine according to claim 2, wherein the library providing the guest virtual memory address to acquire the guest physical memory address by a virtual machine driver pins memory for the guest virtual memory address provided from the library to acquire the guest physical memory address.

4. The direct memory access method for virtual machine according to claim 2, wherein the guest virtual memory address is formed by a plurality of continuous memory paging addresses; the guest physical memory address is formed by a plurality of non-continuous memory paging addresses; and the host virtual memory address is formed by a plurality of non-continuous memory paging addresses.

5. The direct memory access method for virtual machine according to claim 4, wherein the continuous memory paging addresses of the guest virtual memory address and the continuous memory addresses of the continuous memory are in the same order.

6. The direct memory access method for virtual machine according to claim 2, wherein the guest virtual memory address is formed by a plurality of non-continuous memory paging addresses; the guest physical memory address is formed by a plurality of non-continuous memory paging addresses; and the host virtual memory address is formed by a plurality of non-continuous memory paging addresses.

7. The direct memory access method for virtual machine according to claim 6, wherein the non-continuous memory paging addresses of the guest virtual memory address and the continuous memory addresses of the continuous memory are in the same order.

8. The direct memory access method for virtual machine according to claim 1, wherein the shared-memory belongs to a host physical memory addressing space.

9. The direct memory access method for virtual machine according to claim 1, wherein the continuous memory belongs to a host virtual memory addressing space.

10. A direct memory access system for virtual machine, comprising:
at least one guest module, generating a guest physical memory address; and
a host module, coupling to the at least one guest module, comprising:
a memory;
an apparatus driver, coupling to the memory; and
a virtual input/output processor, coupling to the memory and the apparatus driver, acquiring a host virtual memory address according to the guest physical memory address, configuring a shared-memory to access data corresponding to the host virtual memory address, mapping the shared-memory to a continuous memory having a plurality of continuous memory addresses;
wherein the apparatus driver utilizes the continuous memory to access the data corresponding to the host virtual memory address.

11. The direct memory access system for virtual machine according to claim 10, wherein the guest module comprises:
a library, providing a guest virtual memory address; and
a virtual machine driver, coupling to the library, configured for pinning memory for the guest virtual memory address received from the library to acquire the guest physical memory address.

12. The direct memory access system for a virtual machine according to claim 10, wherein the host module comprises:
a virtual machine supervisor, coupling to the virtual input/output processor, configured for generating a guest virtual memory addressing space, a guest physical memory addressing space, a host virtual memory addressing space, and a host physical memory addressing space.

13. The direct memory access system for virtual machine according to claim 11, wherein the guest virtual memory address is formed by a plurality of continuous memory paging addresses; the guest physical memory address is formed by a plurality of non-continuous memory paging addresses; and the host virtual memory address is formed by a plurality of non-continuous memory paging addresses.

14. The direct memory access system for virtual machine according to claim 13, wherein the continuous memory paging addresses of guest virtual memory address and the continuous memory addresses of the continuous memory are in the same order.

15. The direct memory access system for virtual machine according to claim 11, wherein the guest virtual memory address is formed by a plurality of non-continuous memory paging addresses; the guest physical memory address is formed by a plurality of non-continuous memory paging addresses; and the host virtual memory address is formed by a plurality of non-continuous memory paging addresses.

16. The direct memory access system for a virtual machine according to claim 15, wherein the non-continuous memory paging addresses of the guest virtual memory address and the continuous memory addresses of the continuous memory are in the same order.

17. A host module, adapted to access data for a virtual machine, coupling to at least a guest module, the at least guest module providing a guest virtual memory address to acquire a guest physical memory address, comprising:
a memory;
an apparatus driver, coupling to the memory; and
a virtual input/output processor, coupling to the memory and the apparatus driver, acquiring a host virtual memory address according to the guest physical memory address, configuring a shared-memory to access data corresponding to the host virtual memory address, mapping the shared-memory to a continuous memory having a plurality of continuous memory addresses;
wherein the apparatus driver utilizes the continuous memory to access the data corresponding to the host virtual memory address.

18. A host module according to claim 17, further comprising:
a virtual machine supervisor, coupling to the virtual input/output processor, configured for generating a guest virtual memory addressing space, a guest physical memory addressing space, a host virtual memory addressing space, and a host physical memory addressing space.

19. A host module according to claim 18, wherein the shared-memory belongs to a host physical memory addressing space.

20. A host module according to claim 18, wherein the continuous memory belongs to a host virtual memory addressing space.
